(19) United States
(12) Patent Application Publication
(10) Pub. No.: US 2008/0104888 A1
(43) Pub. Date: May 8, 2008

(54) Locking Mechanism

(76) Inventor: Nicholas Mark Holmes, Oxford (GB)

Correspondence Address: Schwartz, Jeffrey J.;Schwartz Law Firm, SouthPark Towers, 6100 Fairview Road, Suite 1135, Charlotte, NC, 28210, US

(21) Appl. No.: 11/665,926

(22) PCT Filed: Oct. 20, 2005
(86) PCT No.: PCT/GB05/04039

§ 371 Date: Nov. 28, 2007

(30) Foreign Application Priority Data
Oct. 21, 2004 (GB) 0423309.4

(51) Int. Cl. E05B 65/00; E06B 7/00; E06B 11/02

(52) U.S. Cl. 49/70; 70/77

(57) ABSTRACT

A locking mechanism (40) for a closure assembly (10) comprises first and second locking members (42, 44) movable between locked and unlocked positions. The locking mechanism (40) includes a control device (46) operably attached to the first and second locking members (42, 44). The control device (46) effects movement of the first and second locking members (42, 44) between their respective locked and unlocked positions.

This invention relates to locking mechanisms for closure assemblies. More particularly but not exclusively, the invention relates to locking mechanisms for child safety gates. This invention also relates to closure assemblies. More particularly, but not exclusively, the invention relates to closure assemblies comprising child safety gates.

Child safety gates need to be secure enough to prevent them from being opened by a child, yet constructed to be easily opened by an adult.

According to one aspect of this invention there is provided a locking mechanism for a closure assembly, the locking mechanism comprising first and second locking members movable between locked and unlocked positions, and a control device operably attached to the first and the second locking members to effect movement of the first and second locking members between their respective locked and the unlocked positions.

The closure assembly may comprise a gate. The closure arrangement may comprise a child safety barrier, which may be a child safety gate.

The locking mechanism may comprise at least one elongate connecting member to connect the control device to the first and second locking members. Preferably the, or each, connecting member comprises a flexible member. The, or each, connecting member may comprise a cable or a cord.

In one embodiment, the connecting member extends through the control device and is attached to both locking members. The locking mechanism may comprise a single connecting member to connect the control device to the first and second locking members.

The control device may comprise a holding member to hold the, or each, connecting member. The holding member may define an aperture through which the connecting member extends.

The control device may be movable between a securing position in which the first and second locking members are in their respective locked positions, and a non-securing position in which the first and second locking members are in their respective unlocked positions.

Urging means may be provided to urge the control device to its securing position. The urging means may comprise a spring.

The control device may comprise a securing member to secure the control device in its securing positions. The securing member may comprise a detent. A release member may be provided to release the securing member to allow the control device to be moved to its non-securing position.

The control device may be slidable relative to the closure arrangement between the aforesaid securing and non-securing position. The control device may comprise a guide part capable of being fixedly mounted on the closure member, and a control part movably mounted on the guide part. Preferably, the control part is slidable relative to the guide part.

Preferably the securing member is movably mounted on the control part and may engage the guide part to secure the control device in its securing position.

The locking mechanism may comprise first and second receiving members to receive locking members. The first and second receiving members may comprise first and second latches respectively.

The first and second locking members may comprise respective first and second pins. First and second urging elements may be provided to urge the respective first and second locking members to their locked positions.

According to another aspect of this invention, there is provided a closure assembly comprising a closure member movable between open and closed positions and a locking mechanism as described above mounted on the closure member.

The first locking member may be provided at an upper region of the closure member. The second locking member may be provided at a lower region of the closure member.

Preferably, the closure assembly comprises a locking support arrangement to receive the first and second locking members when the locking members are in their locked positions to lock the closure member in the closed position.

The locking support arrangement may comprise a first locking support element to receive the first locking member, and a second locking support element to receive the second locking member.

The first locking support element may comprise a base support element, and may extend beneath the closure member. The second locking support element may comprise an upright locking support element, and may extend transverse from the first locking support element, conveniently, in an upright orientation.

The locking support arrangement may comprise fastening means to fasten the closure assembly in a desired position, for example by fastening the closure assembly to the wall.

The closure member may comprise an upper bar upon which the control device can be mounted. The, or each, connecting member may extend through the closure member from the control device to the first and

second locking members. Preferably, the, or each, connecting member may extend through the upper bar. The closure member may also include an upright bar, which may extend transverse to the upper bar and at least some of the, or one, connecting member extends along the upright bar.

Preferably the first locking member is provided in the upper bar. Preferably, the second locking member is provided in the lower bar.

An embodiment of the invention, will now be described by way of example only, with reference to the accompanying drawings in which:

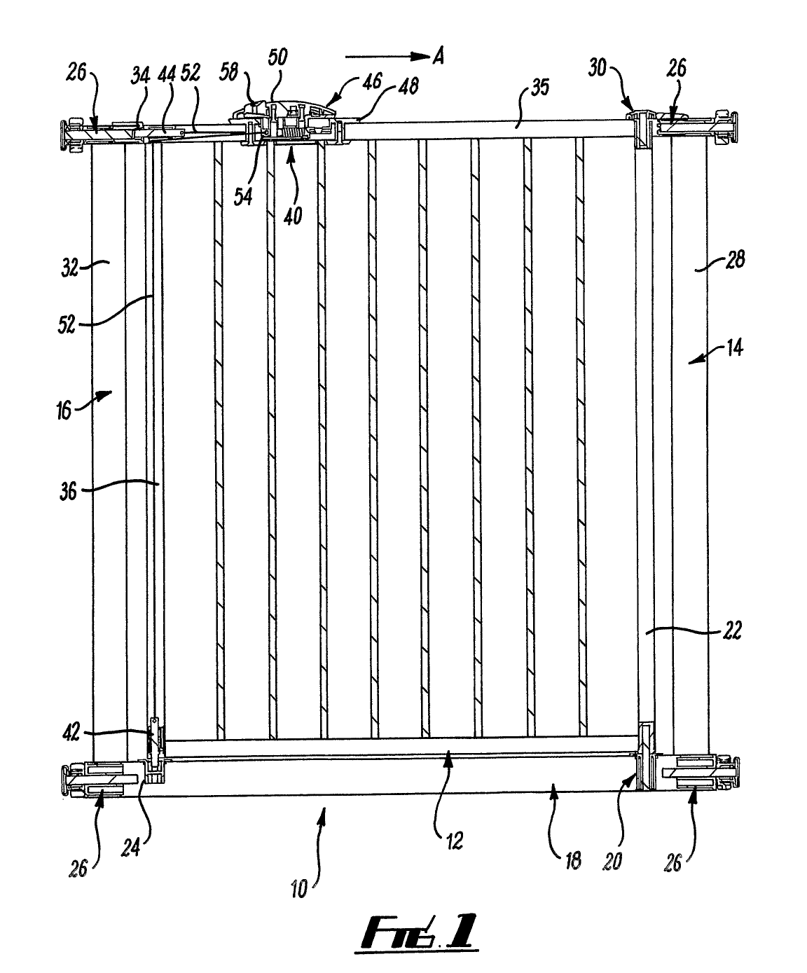

FIG. 1 is a sectional front view of a closure assembly incorporating a locking mechanism;

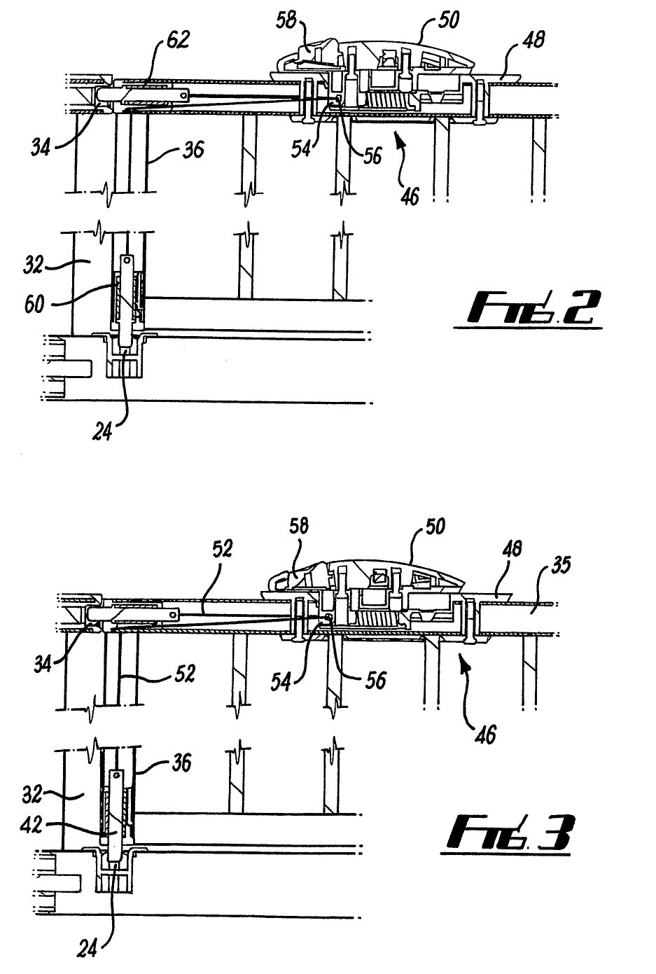

FIG. 2 shows a close up view of parts of the assembly shown in FIG. 1 showing the upper and lower region of closure assembly;

FIG. 3 shows a view similar to FIG. 2 in which a control device is in a condition to unlock the closure assembly;

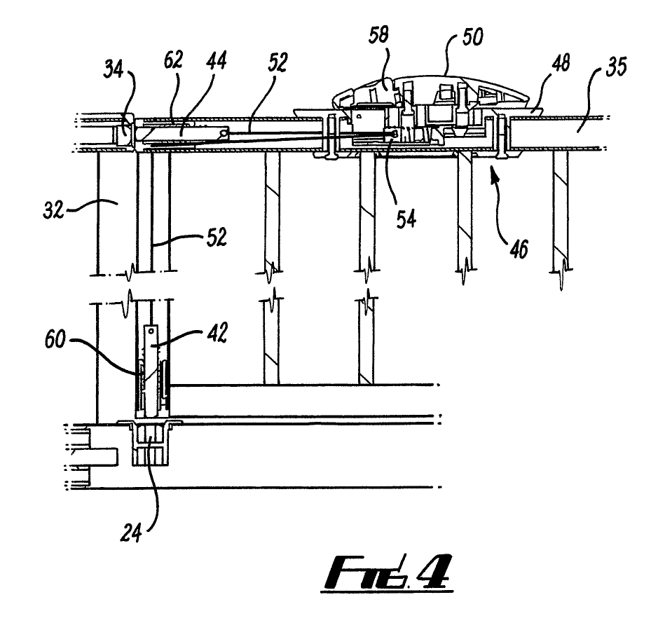

FIG. 4 shows a view similar to FIG. 3 in which the control device has been moved to a non-securing condition;

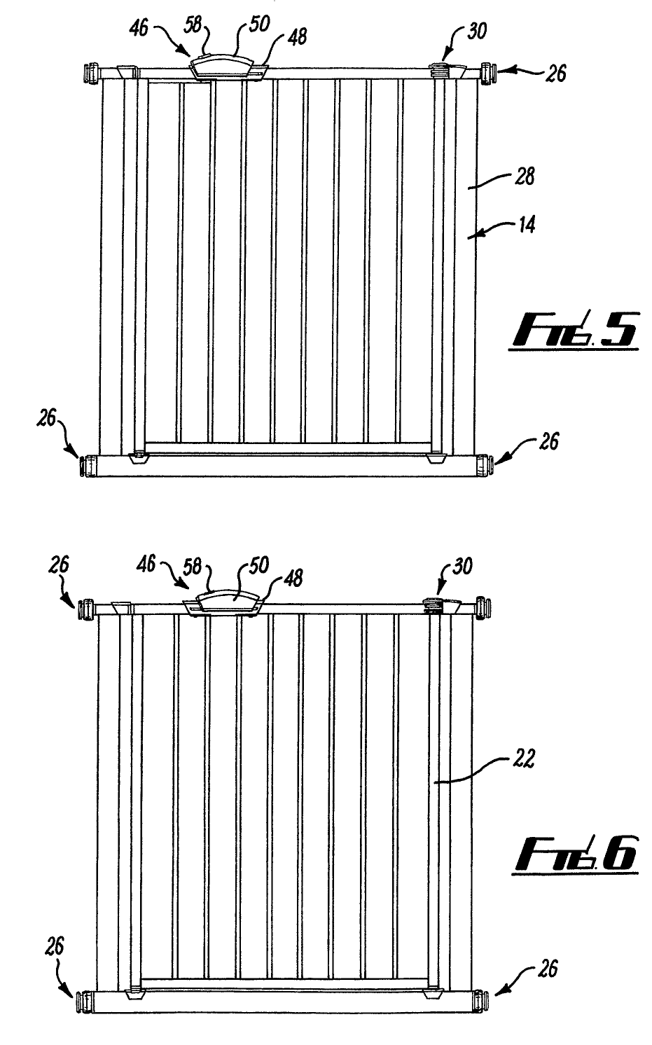

FIG. 5 shows a front view of the closure assembly shown in FIG. 1, in which the control device is in a securing condition, and

FIG. 6 shows a view similar to FIG. 5 in which the control device is in a non-securing condition.

Referring to the drawings, there is shown a closure assembly, in the form of a child safety gate 10. The child safety gate 10 comprises a closure member 12 and opposed first and second upright support arrangements 14, 16 to be secured to opposed fixed supports, such as in a door frame. The child safety gate 10 also comprises a base support element 18 at one end region of which the closure member 12 is mounted by a hinge 20 to the lower end of an upright bar 22 of the closure member 12. The base support element 18 includes a first latch 24 at its opposite end region to the hinge 20. The purpose of the first latch 24 will be explained below. The base support element 18 also includes fastening members 26 at each of its opposite ends to secure the lower region of the closure assembly 10 in a desired position, for example in a doorway or at the top or bottom of the stairs, to prevent a child from injuring him or herself.

The first upright support arrangement 14 also includes a first upright support element 28 extending transverse from, and upright relative to, the base support element 18. The lower end of the upright support element 28 is attached to the base support element 18 in a suitable manner, for example by welding. The upper end of the upright support element 28 has a further fastening member 26 to secure the upper region of the first upright support element 28 to, for example, a wall. The upper region of the first upright support element 28 is connected by a hinge 30 to the upper end of the upright bar 22.

The second support arrangement 16 comprises a second upright support element 32 extending transverse to the base support element 18 and parallel to the first upright support element 28. The upper region of the second upright support element 28 includes another fastening element 26 and a second latch 34, the purpose of which is explained below.

It will be appreciated that the hinges 20, 30 and the fastening members 26 would be of a construction well known to persons skilled in the art. As a result, they are not described in detail in this specification.

The closure member 12 comprises an upper bar 35 which is tubular, and a second upright bar 36 on the opposite edge of the closure member 12 to the first upright bar 22. the second upright bar 36 is adjacent to the second upright support element 32 when the closure member 12 is in its closed condition. The second upright bar 36 is also tubular.

The closure assembly 10 includes a locking mechanism 40, which comprise a first locking member in the form of a first locking pin 42 and a second locking member in the form of a second locking pin 44. The first locking pin 42 can be received in the first latch 24, and the second locking pin 44 can be received in the second latch 34.

In FIG. 1 the closure member 12 is in its closed position, and the first and second locking pins 42, 44 are in their locked positions, i.e. received in the respective first and second latches 24, 34. The first and second locking pins 42, 44 can be moved to respective unlocked positions, as described below.

The locking mechanism 40 further comprises a control device 46 comprising a guide part 48 fixedly mounted, for example by screws, to the upper bar 35 of the closure member 12. The control device 46 includes a control part 50 slidably mounted on the guide part 48. The control part 50 is slidable from a securing position, as shown in FIGS. 1, 2, 3 and 5 in which the first and second locking pins 42, 44 are received in the respective first and second latches 24, 34 to a non-securing position as shown in FIGS. 4 and 6 in which the first and second locking pins 42, 44 are retracted from the first and second latches 24, 34 to allow the closure member 12 to be opened.

The control part 50 of the control device 46 is connected to the first and second locking pins 42, 44 by a flexible elongate connecting member 52 in the form of a cable or cord. The connecting member 52 is attached to the first locking pin 42 and extends therefrom to the control part 50 of the control device 46. The control device 46 includes a holding member in the form of a lug 54 defining an aperture 56. The connecting member 52 extends through the aperture 56 down the second upright bar 36 to the second locking pin 44 to which it is attached. Thus, by pulling the control part 50 of the control device 46 in the direction indicated by the arrow A in FIG. 1, the control part 50 pulls on the connecting member 52 to retract the first and second locking pins 42, 44 from their respective first and second latches 24, 34.

The control part 50 comprises s securing member operable by a release member in the form of a button 58. The securing member engages the guide part 48, and when the button 58 is pressed, as shown in FIG. 3, the securing member is disengaged from the guide part 48 to allow the control part 50 to be slid in the direction of the arrow A in FIG. 3 to the position shown in FIG. 4. In this position, the first and second locking pins 42, 44 are retracted from the first and second latches 24, 30 and the closure member 12 can be opened.

The first and second locking pins 42, 44 include locking springs 60, 62 to urge the locking pins 42, 44 to their locked positions. Similarly, a spring 64 is provided in the control device 46 to urge the control part 50 to its securing position shown in FIGS. 1, 2 and 3.

Thus, by releasing the control part 50 of the control device 46 the control part moves under the force of the spring 64 in the direction opposite to the arrow A to the securing position shown in FIGS. 1 and 2, and the locking springs 60, 62 urge the first and second locking pins 42, 44 into the respective first and second latches 24, 30.

FIG. 5 shows the child safety gate 10 with the control device 46 in the securing position, so that the first and second locking pins 42, 44 are received in the first and second latches 24, 34 thereby locking the closure member 12 in its closed position.

FIG. 6 shows the child safety gate 10 with the control device 46 in the non-securing position so that the first and second locking pin 42, 44 are retracted from the first and second locking pins 42, 44 are retracted from the first and second latches 24, 30 to allow the closure member 12 to be opened.

There is thus described, as a preferred embodiment of a closure assembly, a child safety gate 10 which includes a locking mechanism of simple construction in which the gate can be locked a the top and bottom of the closure member 12 and can be unlocked by a single movement of a control device.

Various modifications can be made without departing from the scope of the invention.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A locking mechanism for a closure assembly, the locking mechanism comprising first and second locking members movable between respective locked and unlocked positions, and a control device operably attached to the first and the second locking members to effect movement of the first and second locking members between their respective locked and the unlocked positions.

2. A locking mechanism according to claim 1 comprising at least one elongate connecting member to connect the control device to the first and second locking members.

3. A locking mechanism according to claim 2 wherein the, or each, connecting member comprises a flexible member.

4. A locking mechanism according to claim 2 wherein the, or each, connecting member comprises a cable or a cord.

5. A locking mechanism according to claim 2 wherein the connecting member extends through the control device and is attached to both locking members.

6. A locking mechanism according to claim 2 wherein the locking mechanism may comprise no more than one connecting member to connect the control device to the first and second locking members.

7. A locking mechanism according to claim 2 wherein the control device comprises a holding member to hold the, or each, connecting member, the holding member defining an aperture through which the connecting member extends.

8. A locking mechanism according claim 1 wherein the control device is movable between a securing position in which the first and second locking members are in their respective locked positions, and a non-securing position in which the first and second locking members are in their respective unlocked positions.

9. A locking mechanism according to claim 8 comprising urging means to urge the control device to its securing position.

10. A locking mechanism according to claim 9 wherein the urging means comprises a spring.

11. A locking mechanism according to claim 8 wherein the control device comprises a securing member to secure the control device in its securing positions.

12. A locking mechanism according to claim 11 wherein the securing member comprises a detent.

13. A locking mechanism according to claim 11 wherein a release member is provided to release the securing member to allow the control device to be moved to its non-securing position.

14. A locking mechanism according to claim 8 wherein the control device is slidable relative to the closure arrangement between the aforesaid securing and non-securing position.

15. A locking mechanism according to claim 8 wherein the control device may comprise a guide part capable of being fixedly mounted on the closure member, and a control part movably mounted on the guide part. Preferably, the control part is slidable relative to the guide part.

16. A locking mechanism according to claim 15 wherein the control part is slidable relative to the guide part.

17. A locking mechanism according to claim 15 wherein the securing member is movably mounted on the control part and engages the guide part to secure the control device in its securing position.

18. A locking mechanism according to claim 1 comprising first and second receiving members to receive the locking members.

19. A locking mechanism according to claim 18 wherein the first and second receiving members comprises first and second latches respectively.

20. A locking mechanism according to claim 1 wherein the first and second locking members comprise respective first and second pins, and first and second urging elements are provided to urge the respective first and second locking members to their locked positions.

21. A closure assembly comprising a closure member movable between open and closed positions and a locking mechanism as claimed claim 1 mounted on the closure member.

22. A closure assembly according to claim 21 wherein the first locking member is provided at an upper region of the closure member, and the second locking member is provided at a lower region of the closure member.

23. A closure assembly according to claim 21 wherein the closure assembly comprises a locking support arrangement to receive the first and second locking members when the locking members are in their locked positions to lock the closure member in the closed position.

24. A closure assembly according to claim 23 wherein the locking support arrangement comprises a first locking support element to receive the first locking member, and a second locking support element to receive the second locking member.

25. A closure assembly according to claim 24 wherein the first locking support element comprises a base support element, and extends beneath the closure member, and the second locking support element comprises an upright locking support element, and extends transverse from the first locking support element.

26. A closure assembly according to claim 25 wherein the second locking support element extends in an upright orientation.

27. A closure assembly according claim 21 comprising fastening means to fasten the closure assembly in a desired position.

28. A closure assembly according claim 21 wherein the closure member comprises an upper bar upon which the control device can be mounted, the, or each, connecting member extending through the closure member from the control device to the first and second locking members.

29. A closure assembly according to claim 28 wherein the, or each, connecting member extends through the upper bar.

30. A closure assembly according to claim 28 wherein the closure member includes an upright bar, which extends transverse to the upper bar and at least some of the, or one, connecting member extends along the upright bar.

31. A closure assembly according to claim 28 wherein the second locking member is provided in the upper bar, and the first locking member is provided in the upright bar.

32. (canceled)

33. (canceled)

34. (canceled)
